(19) United States
(12) Patent Application Publication
(10) Pub. No.: US 2003/0101104 A1
(43) Pub. Date: May 29, 2003

(54) System and method for retrieving information related to targeted subjects

(75) Inventors: Nevenka Dimitrova, Yorktown Heights, NY (US); Dongge Li, Ossining, NY (US); Lalitha Agnihotri, Fishkill, NY (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/995,471

(22) Filed: Nov. 28, 2001

(51) Int. Cl. G06F 17/60

(52) U.S. Cl. 705/27; 345/968

(57) ABSTRACT

An information tracking device receives content data, such as a video or television signal from one or more information sources and analyzes the content data according to a query criteria to extract relevant stories. The query criteria utilizes a variety of information, such as but not limited to a user request, a user profile, and a knowledge base of known relationships. Using the query criteria, the information tracking device calculates a probability of a person or event occurring in the content data and spots and extracts stories accordingly. The results are index, ordered, and then displayed on a display device.

### FIELD OF THE INVENTION

The present invention relates to an interactive information retrieval system and method of retrieving information related to targeted subjects from multiple information sources. In particular, the present invention relates to a content analyzer that is communicatively connected to a plurality of information sources, and is capable of receiving implicit and explicit requests for information from a user to extract relevant stories from the information sources.

### BACKGROUND OF INVENTION

With some 500+ channels of available television content and endless streams of content accessible via the Internet, it might seem that one would always have access to desirable content. However, to the contrary, viewers are often unable to find the type of content they are seeking. This can lead to a frustrating experience.

Presently, cable and satellite television services alike provide viewing guides aimed at helping viewers find interesting programs. In one such system, the viewer flips to the guide channel and watches a cascading stream of programs that are airing (or that will be airing) within a given time interval (typically 2-3 hours). The program listings simply scroll in order by channel. Thus, the viewer has no control and often has to sit through hundreds of channels before finding the desired program. In another system, users can access a viewing guide on their television screens. The viewing guide is somewhat interactive in that users can select the particular time, day, and channel that they are interested in. However, these services do not allow the user to search for particular content. In addition, these viewing guides fail to provide a mechanism for retrieving information related to a targeted subject, such as an actor or actress, a particular event, or a particular topic.

On the Internet, a user looking for content can type a search request into a search engine. However, these search engines are often hit or miss and can be very inefficient to use. Furthermore, current search engines are unable to continuously access relevant content to update results over time. There are also specialized web sites and news groups (e.g., sports sites, movie sites, etc.) for users to access. However, these sites require users to log in and inquire about a particular topic each time the user desires information.

Moreover, there is no system available that integrates information retrieving capability across various media types, such as television and the Internet, and can extract people or stories from multiple channels and site. Nor is there a system where users with common interests can share their knowledge and integrate it with their television watching experience.

Thus there is a need for a system and method for permitting a user to create a targeted request for information, which request is processed by a computing device having access to multiple information sources to retrieve information related to the subject of the request.

### SUMMARY OF THE INVENTION

The present invention overcomes the shortcomings of the prior art. Generally, an information tracker comprises a content analyzer comprising a memory for storing content data received from an information source and a processor for executing a set of machine-readable instructions for analyzing the content data according to query criteria. The information tracker further comprises an input device communicatively connected to the content analyzer for permitting a user to interact with the content analyzer and a display device communicatively connected to the content analyzer for displaying a result of analysis of the content data performed by the content analyzer. According to the set of machine-readable instructions, the processor of the content analyzer analyzes the content data to extract and index one or more stories related to the query criteria.

More specifically, in an exemplary embodiment, the processor of the content analyzer uses the query criteria to spot a subject in the content data, extract one or more stories from the content data, resolve and infer names in the extracted one or more stories, and display a link to the extracted one or more stories on the display device. If more than one story is extracted, the processor indexes and orders the stories according to various criteria, including but not limited to name, topic, and keyword, temporal relationships and causality relationships.

The content analyzer also further comprises a user profile, which includes information about the user's interests and a knowledge base which includes a plurality of known relationships including a map of known faces and voices to names and other related information. The query criteria preferably incorporates information in the user profile and the knowledge base into the analysis of the content data.

In general, the processor, according to the machine readable instructions performs several steps to make the most relevant matches to a user's request or interests, including but not limited to person spotting, story extraction, inferencing and name resolution, indexing, results presentation, and user profile management. More specifically, according to an exemplary embodiment, a person spotting function of the machine-readable instructions extracts faces, speech, and text from the content data, makes a first match of known faces to the extracted faces, makes a second match of known voices to the extracted voices, scans the extracted text to make a third match to known names, and calculates a probability of a particular person being present in the content data based on the first, second, and third matches. In addition, a story extraction function preferably segments audio, video and transcript information of the content data, performs information fusion, internal story segmentation/annotation, and inferencing and name resolution to extract relevant stories.

The above and other features and advantages of the present invention will become readily apparent from the following detailed description thereof, which is to be read in connection with the accompanying drawings.

### BRIEF DESCRIPTION OF THE DRAWINGS

In the drawing figures, which are merely illustrative, and wherein like reference numerals depict like elements throughout the several views:

FIG. 1 is a schematic diagram of an overview of an exemplary embodiment of an information retrieval system in accordance with the present invention;

FIG. 2 is a schematic diagram of an alternate embodiment of an information retrieval system in accordance with the present invention;

FIG. 3 is a is a flow diagram of a method of information retrieval in accordance with the present invention;

FIG. 4 is a flow diagram of a method of person spotting and recognition in accordance with the present invention;

FIG. 5 is a flow diagram of a method of story extraction;

FIG. 6 is a flow diagram of a method of indexing the extracted stories; and

FIG. 7 is a diagram of an exemplary ontological knowledge tree in accordance with the present invention.

### DETAILED DESCRIPTION OF THE PREFERRED EMBODIMENTS

The present invention is directed to an interactive system and method for retrieving information from multiple media sources according to a profile or request of a user of the system.

In particular, an information retrieval and tracking system is communicatively connected to multiple information sources. Preferably, the information retrieval and tracking system receives media content from the information sources as a constant stream of data. In response to a request from a user (or triggered by a user's profile), the system analyzes the content data and retrieves that data most closely related to the request or profile. The retrieved data is either displayed or stored for later display on a display device.

System Architecture

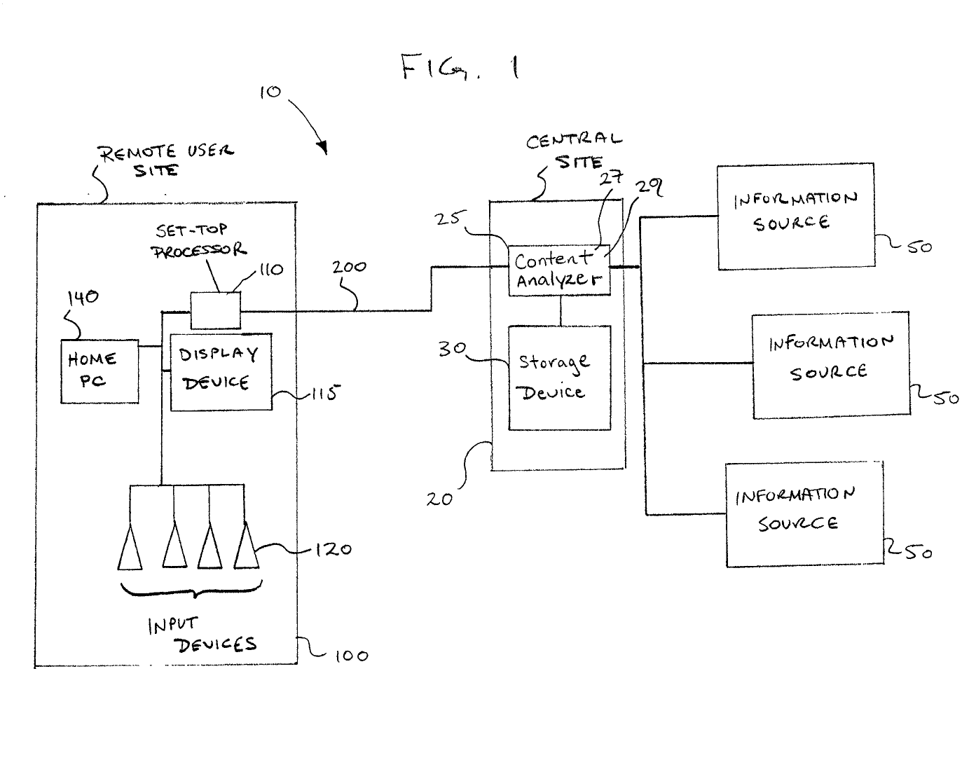

With reference to FIG. 1, there is shown a schematic overview of a first embodiment of an information retrieval system 10 in accordance with the present invention. A centralized content analysis system 20 is interconnected to a plurality of information sources 50. By way of non-limiting example, information sources 50 may include cable or satellite television and the Internet. The content analysis system 20 is also communicatively connected to a plurality of remote user sites 100, described further below.

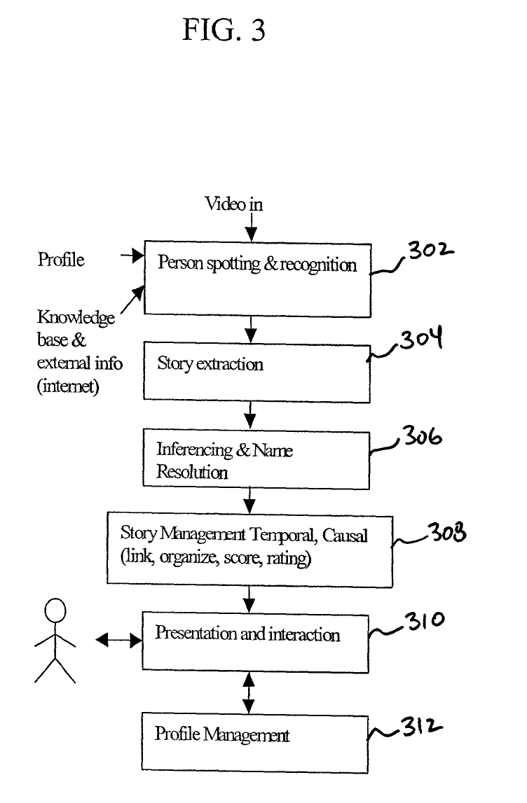

In the first embodiment, shown in FIG. 1, centralized content analysis system 20 comprises a content analyzer 25 and one or more data storage devices 30. The content analyzer 25 and the storage devices 30 are preferably interconnected via a local or wide area network. The content analyzer 25 comprises a processor 27 and a memory 29, which are capable of receiving and analyzing information received from the information sources 50. The processor 27 may be a microprocessor and associated operating memory (RAM and ROM), and include a second processor for pre-processing the video, audio and text components of the data input. The processor 27, which may be, for example, an Intel Pentium chip or other more powerful multiprocessor, is preferably powerful enough to perform content analysis on a frame-by-frame basis, as described below. The functionality of content analyzer 25 is described in further detail below in connection with FIGS. 3-5.

The storage devices 30 may be a disk array or may comprise a hierarchical storage system with tera, peta and exabytes of storage devices, optical storage devices, each preferably having hundreds or thousands of giga-bytes of storage capability for storing media content. One skilled in the art will recognize that any number of different storage devices 30 may be used to support the data storage needs of the centralized content analysis system 20 of an information retrieval system 10 that accesses several information sources 50 and can support multiple users at any given time.

As described above, the centralized content analysis system 20 is preferably communicatively connected to a plurality of remote user sites 100 (e.g., a user's home or office), via a network 200. Network 200 is any global communications network, including but not limited to the Internet, a wireless/satellite network, cable network, any the like. Preferably, network 200 is capable of transmitting data to the remote user sites 100 at relatively high data transfer rates to support media rich content retrieval, such as live or recorded television.

As shown in FIG. 1, each remote site 100 includes a set-top box 110 or other information receiving device. A set-top box is preferable because most set-top boxes, such as TiVo®, WebTB®, or UltimateTV®, are capable of receiving several different types of content. For instance, the UltimateTV® set-top box from Microsoft® can receive content data from both digital cable services and the Internet. Alternatively, a satellite television receiver could be connected to a computing device, such as a home personal computer 140, which can receive and process web content, via a home local area network. In either case, all of the information receiving devices are preferably connected to a display device 115, such as a television or CRT/LCD display.

Users at the remote user sites 100 generally access and communicate with the set-top box 110 or other information receiving device using various input devices 120, such as a keyboard, a multi-function remote control, voice activated device or microphone, or personal digital assistant. Using such input devices 120, users can input personal profiles or make specific requests for a particular category of information to be retrieved, as described further below.

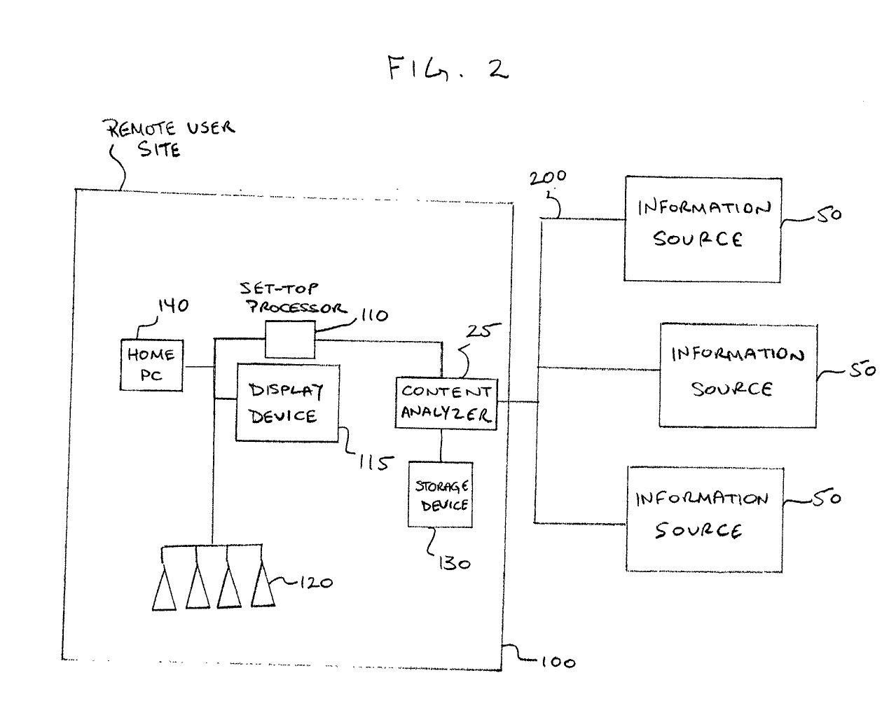

In an alternate embodiment, shown in FIG. 2, a content analyzer 25 is located at each remote site 100 and is communicatively connected to the information sources 50. In this alternate embodiment, the content analyzer 25 may be integrated with a high capacity storage device or a centralized storage device (not shown) can be utilized. In either instance, the need for a centralized analysis system 20 is eliminated in this embodiment. The content analyzer 25 may also be integrated into any other type of computing device 140 that is capable of receiving and analyzing information from the information sources 50, such as, by way of non-limiting example, a personal computer, a hand held computing device, a gaming console having increased processing and communications capabilities, a cable set-top box, and the like. A secondary processor, such as the TriMedia™ Tricodec card may be used in said computing device 140 to pre-process video signals. However, in FIG. 2 to avoid confusion, the content analyzer 25, the storage device 130, and the set-top box 110 are each depicted separately.

Functioning of Content Analyzer

As will become evident from the following discussion, the functionality of the information retrieval system 10 has equal applicability to both television/video based content and web-based content. The content analyzer 25 is preferably programmed with a firmware and software package to deliver the functionalities described herein. Upon connecting the content analyzer 25 to the appropriate devices, i.e., a television, home computer, cable network, etc., the user would preferably input a personal profile using input device 120 that will be stored in a memory 29 of the content analyzer 25. The personal profile may include information such as, for example, the user personal interests (e.g., sports, news, history, gossip, etc.), persons of interest (e.g., celebrities, politicians, etc.), or places of interest (e.g., foreign cities, famous sites, etc.), to name a few. Also, as described below, the content analyzer 25 preferably stores a knowledge base from which to draw known data relationships, such as G. W. Bush is the President of the United States.

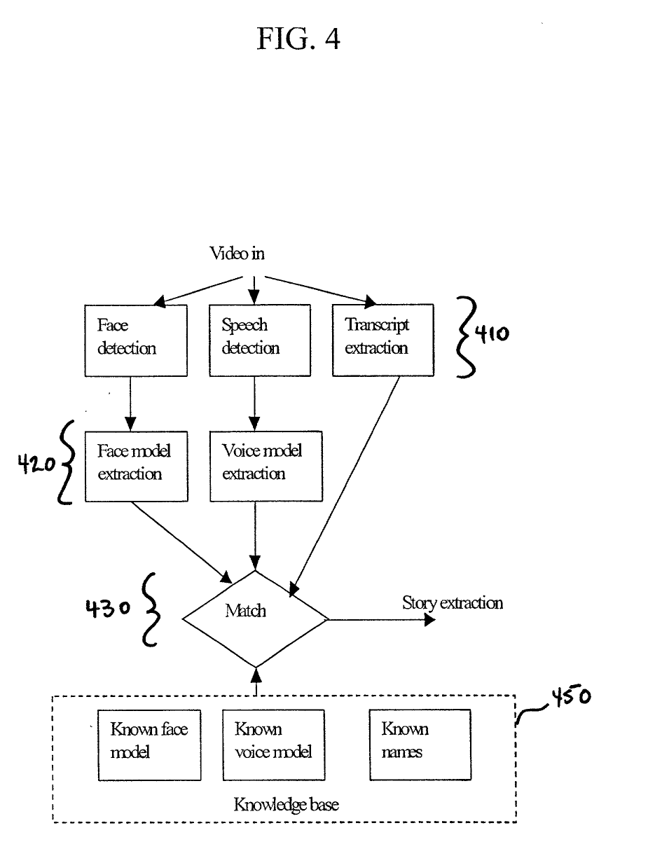

With reference to FIG. 3, the functionality of the content analyzer will be described in connection with the analysis of a video signal. In step 302, the content analyzer 25 performs a video content analysis using audio visual and transcript processing to perform person spotting and recognition using, for example, a list of celebrity or politician names, voices, or images in the user profile and/or knowledge base and external data source, as described below in connection with FIG. 4. In a real-time application, the incoming content stream (e.g., live cable television) is buffered either in the storage device 30 at the central site 20 or in the local storage device 130 at the remote site 100 during the content analysis phase. In other non-real-time applications, upon receipt of a request or other prescheduled event (described below), the content analyzer 25 accesses the storage device 30 or 130, as applicable, and performs the content analysis.

Because most cable and satellite television signals carry hundreds of channels it is preferable to target only those channels that are most likely to produce relevant stories. For this purpose the content analyzer 25 may be programmed with knowledge base 450 or field database to aid the processor 27 in determining a “field types” for the user's request. For example, the name Dan Marino in the field database might be mapped to the field “sports”. Similarly, the term “terrorism” might be mapped to the field “news”. In either instance, upon determination of a field type, the content analyzer would then only scan those channels relevant to the field (e.g., news channels for the field “news”). While these categorizations are not required for operation of the content analysis process, using the user's request to determine a field type is more efficient and would lead to quicker story extraction. In addition, it should be noted that the mapping of particular terms to fields is a matter of design choice and could be implemented in any number of ways.

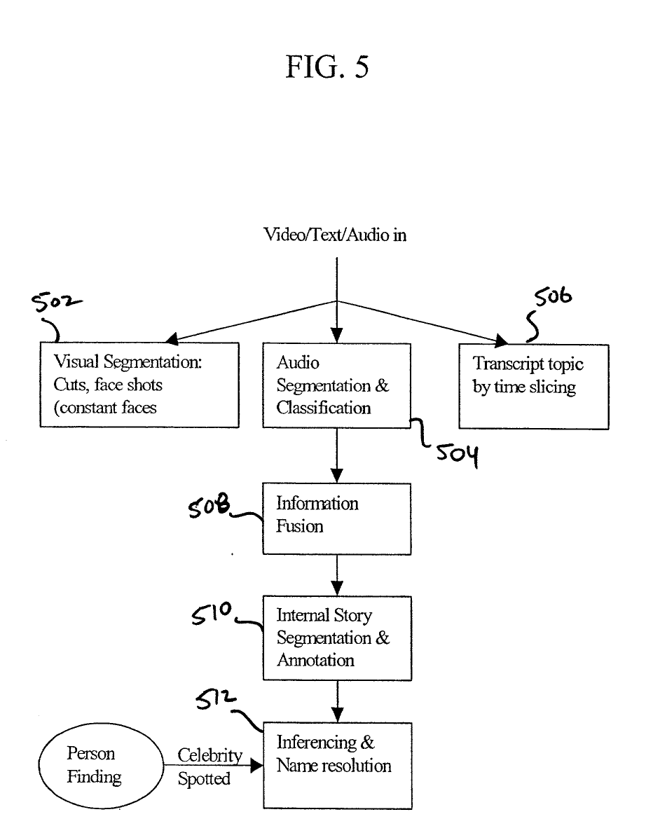

Next, in step 304, the video signal is further analyzed to extract stories from the incoming video. Again, the preferred process is described below in connection with FIG. 5. It should be noted that the person spotting and recognition can also be executed in parallel with story extraction as an alternative implementation.

An exemplary method of performing content analysis on a video signal, such as a television NTSC signal, which is the basis for both the person spotting and story extraction functionality, will now be described. Once the video signal is buffered, the processor 27 of the content analyzer 25, preferably uses a Bayesian or fusion software engine, as described below, to analyze the video signal. For example, each frame of the video signal may be analyzed so as to allow for the segmentation of the video data.

With reference to FIG. 4, a preferred process of performing person spotting and recognition will be described. At level 410, face detection, speech detection, and transcript extraction is performed substantially as described above. Next, at level 420, the content analyzer 25 performs face model and voice model extraction by matching the extracted faces and speech to known face and voice models stored in the knowledge base. The extracted transcript is also scanned to match known names stored in the knowledge base. At level 430, using the model extraction and name matches, a person is spotted or recognized by the content analyzer. This information is then used in conjunction with the story extraction functionality as shown in FIG. 5.

By way of example only, a user may be interested in political events in the mid-east, but will be away on vacation on a remote island in South East Asia; thus, unable to receive news updates. Using input device 120, the user can enter keywords associated with the request. For example, the user might enter Israel, Palestine, Iraq, Iran, Ariel Sharon, Saddam Hussein, etc. These key terms are stored in a user profile on a memory 29 of the content analyzer 25. As discussed above, a database of frequently used terms or persons is stored in the knowledge base of the content analyzer 25. The content analyzer 25 looks-up and matches the inputted key terms with terms stored in the database. For example, the name Ariel Sharon is matched to Israeli Prime Minister, Israel is matched to the mid-east, and so on. In this scenario, these terms might be linked to a news field type. In another example, the names of sports figures might return a sports field result.

Using the field result, the content analyzer 25 accesses the most likely areas of the information sources to find related content. For example, the information retrieval system might access news channels or news related web sites to find information related to the request terms.

With reference now to FIG. 5, an exemplary method of story extraction will be described and shown. First, in steps 502, 504, and 506, the video/audio source is preferably analyzed to segment the content into visual, audio and textual components, as described below. Next, in steps 508 and 510, the content analyzer 25 performs information fusion and internal segmentation and annotation. Lastly, in step 512, using the person recognition result, the segmented story is inferenced and the names are resolved with the spotted subject.

Such methods of video segmentation include but are not limited to cut detection, face detection, text detection, motion estimation/segmentation/detection, camera motion, and the like. Furthermore, an audio component of the video signal may be analyzed. For example, audio segmentation includes but is not limited to speech to text conversion, audio effects and event detection, speaker identification, program identification, music classification, and dialogue detection based on speaker identification. Generally speaking, audio segmentation involves using low-level audio features such as bandwidth, energy and pitch of the audio data input. The audio data input may then be further separated into various components, such as music and speech. Yet further, a video signal may be accompanied by transcript data (for closed captioning system), which can also be analyzed by the processor 27. As will be described further below, in operation, upon receipt of a retrieval request from a user, the processor 27 calculates a probability of the occurrence of a story in the video signal based upon the plain language of the request and can extract the requested story.

Prior to performing segmentation, the processor 27 receives the video signal as it is buffered in a memory 29 of the content analyzer 25 and the content analyzer accesses the video signal. The processor 27 de-multiplexes the video signal to separate the signal into its video and audio components and in some instances a text component. Alternatively, the processor 27 attempts to detect whether the audio stream contains speech. An exemplary method of detecting speech in the audio stream is described below. If speech is detected, then the processor 27 converts the speech to text to create a time-stamped transcript of the video signal. The processor 27 then adds the text transcript as an additional stream to be analyzed.

Whether speech is detected or not, the processor 27 then attempts to determine segment boundaries, i.e., the beginning or end of a classifiable event. In a preferred embodiment, the processor 27 performs significant scene change detection first by extracting a new keyframe when it detects a significant difference between sequential I-frames of a group of pictures. As noted above, the frame grabbing and keyframe extracting can also be performed at pre-determined intervals. The processor 27 preferably, employs a DCT-based implementation for frame differencing using cumulative macroblock difference measure. Unicolor keyframes or frames that appear similar to previously extracted keyframes get filtered out using a one-byte frame signature. The processor 27 bases this probability on the relative amount above the threshold using the differences between the sequential I-frames.

A method of frame filtering is described in U.S. Pat. No. 6,125,229 to Dimitrova et al. the entire disclosure of which is incorporated herein by reference, and briefly described below. Generally speaking the processor receives content and formats the video signals into frames representing pixel data (frame grabbing). It should be noted that the process of grabbing and analyzing frames is preferably performed at pre-defined intervals for each recording device. For instance, when the processor begins analyzing the video signal, keyframes can be grabbed every 30 seconds.

Once these frames are grabbed every selected keyframe is analyzed. Video segmentation is known in the art and is generally explained in the publications entitled, N. Dimitrova, T. McGee, L. Agnihotri, S. Dagtas, and R. Jasinschi, “On Selective Video Content Analysis and Filtering,” presented at SPIE Conference on Image and Video Databases, San Jose, 2000; and “Text, Speech, and Vision For Video Segmentation: The Infomedia Project” by A. Hauptmann and M. Smith, AAAI Fall 1995 Symposium on Computational Models for Integrating Language and Vision 1995, the entire disclosures of which are incorporated herein by reference. Any segment of the video portion of the recorded data including visual (e.g., a face) and/or text information relating to a person captured by the recording devices will indicate that the data relates to that particular individual and, thus, may be indexed according to such segments. As known in the art, video segmentation includes, but is not limited to:

Significant scene change detection: wherein consecutive video frames are compared to identify abrupt scene changes (hard cuts) or soft transitions (dissolve, fade-in and fade-out). An explanation of significant scene change detection is provided in the publication by N. Dimitrova, T. McGee, H. Elenbaas, entitled “Video Keyframe Extraction and Filtering: A Keyframe is Not a Keyframe to Everyone”, Proc. ACM Conf. on Knowledge and Information Management, pp. 113-120, 1997, the entire disclosure of which is incorporated herein by reference.

Face detection: wherein regions of each of the video frames are identified which contain skin-tone and which correspond to oval-like shapes. In the preferred embodiment, once a face image is identified, the image is compared to a database of known facial images stored in the memory to determine whether the facial image shown in the video frame corresponds to the user's viewing preference. An explanation of face detection is provided in the publication by Gang Wei and Ishwar K. Sethi, entitled “Face Detection for Image Annotation”, Pattern Recognition Letters, Vol. 20, No. 11, November 1999, the entire disclosure of which is incorporated herein by reference.

Motion Estimation/Segmentation/Detection: wherein moving objects are determined in video sequences and the trajectory of the moving object is analyzed. In order to determine the movement of objects in video sequences, known operations such as optical flow estimation, motion compensation and motion segmentation are preferably employed. An explanation of motion estimation/segmentation/detection is provided in the publication by Patrick Bouthemy and Francois Edouard, entitled “Motion Segmentation and Qualitative Dynamic Scene Analysis from an Image Sequence”, International Journal of Computer Vision, Vol. 10, No. 2, pp. 157-182, April 1993, the entire disclosure of which is incorporated herein by reference.

The audio component of the video signal may also be analyzed and monitored for the occurrence of words/sounds that are relevant to the user's request. Audio segmentation includes the following types of analysis of video programs: speech-to-text conversion, audio effects and event detection, speaker identification, program identification, music classification, and dialog detection based on speaker identification.

Audio segmentation and classification includes division of the audio signal into speech and non-speech portions. The first step in audio segmentation involves segment classification using low-level audio features such as bandwidth, energy and pitch. Channel separation is employed to separate simultaneously occurring audio components from each other (such as music and speech) such that each can be independently analyzed. Thereafter, the audio portion of the video (or audio) input is processed in different ways such as speech-to-text conversion, audio effects and events detection, and speaker identification. Audio segmentation and classification is known in the art and is generally explained in the publication by D. Li, I. K. Sethi, N. Dimitrova, and T. Mcgee, “Classification of general audio data for content-based retrieval,” Pattern Recognition Letters, pp. 533-544, Vol. 22, No. 5, April 2001, the entire disclosure of which is incorporated herein by reference.

Speech-to-text conversion (known in the art, see for example, the publication by P. Beyerlein, X. Aubert, R. Haeb-Umbach, D. Klakow, M. Ulrich, A. Wendemuth and P. Wilcox, entitled “Automatic Transcription of English Broadcast News”, DARPA Broadcast News Transcription and Understanding Workshop, VA, Feb. 8-11, 1998, the entire disclosure of which is incorporated herein by reference) can be employed once the speech segments of the audio portion of the video signal are identified or isolated from background noise or music. The speech-to-text conversion can be used for applications such as keyword spotting with respect to event retrieval.

Audio effects can be used for detecting events (known in the art, see for example the publication by T. Blum, D. Keislar, J. Wheaton, and E. Wold, entitled “Audio Databases with Content-Based Retrieval”, Intelligent Multimedia Information Retrieval, AAAI Press, Menlo Park, Calif., pp. 113-135, 1997, the entire disclosure of which is incorporated herein by reference). Stories can be detected by identifying the sounds that may be associated with specific people or types of stories. For example, a lion roaring could be detected and the segment could then be characterized as a story about animals.

Speaker identification (known in the art, see for example, the publication by Nilesh V. Patel and Ishwar K. Sethi, entitled “Video Classification Using Speaker Identification”, IS&T SPIE Proceedings: Storage and Retrieval for Image and Video Databases V, pp. 218-225, San Jose, Calif., February 1997, the entire disclosure of which is incorporated herein by reference) involves analyzing the voice signature of speech present in the audio signal to determine the identity of the person speaking. Speaker identification can be used, for example, to search for a particular celebrity or politician.

Music classification involves analyzing the non-speech portion of the audio signal to determine the type of music (classical, rock, jazz, etc.) present. This is accomplished by analyzing, for example, the frequency, pitch, timbre, sound and melody of the non-speech portion of the audio signal and comparing the results of the analysis with known characteristics of specific types of music. Music classification is known in the art and explained generally in the publication entitled “Towards Music Understanding Without Separation: Segmenting Music With Correlogram Comodulation” by Eric D. Scheirer, 1999 IEEE Workshop on Applications of Signal Processing to Audio and Acoustics, New Paltz, N.Y. Oct. 17-20, 1999.

Preferably, a multimodal processing of the video/text/audio is performed using either a Bayesian multimodal integration or a fusion approach. By way of example only, in an exemplary embodiment the parameters of the multimodal process include but are not limited to: the visual features, such as color, edge, and shape; audio parameters such as average energy, bandwidth, pitch, mel-frequency cepstral coefficients, linear prediction coding coefficients, and zero-crossings. Using such parameters, the processor 27 create the mid-level features, which are associated with whole frames or collections of frames, unlike the low-level parameters, which are associated with pixels or short time intervals. Keyframes (first frame of a shot, or a frame that is judged important), faces, and videotext are examples of mid-level visual features; silence, noise, speech, music, speech plus noise, speech plus speech, and speech plus music are examples of mid-level audio features; and keywords of the transcript along with associated categories make up the mid-level transcript features. High-level features describe semantic video content obtained through the integration of mid-level features across the different domains. In other words, the high level features represent the classification of segments according to user or manufacturer defined profiles, described further in Method and Apparatus for Audio/Data/Visual Information Selection, Nevenka Dimitrova, Thomas McGee, Herman Elenbaas, Lalitha Agnihotri, Radu Jasinschi, Serhan Dagtas, Aaron Mendelsohn filed Nov. 18, 1999, Ser. No. 09/442,960, the entire disclosure of which is incorporated herein by reference.

The various components of the video, audio, and transcript text are then analyzed according to a high level table of known cues for various story types. Each category of story preferably has knowledge tree that is an association table of keywords and categories. These cues may be set by the user in a user profile or pre-determined by a manufacturer. For instance, “Minnesota Vikings” tree might include keywords such as sports, football, NFL, etc. In another example, a “presidential” story can be associated with visual segments, such as the presidential seal, pre-stored face data for George W. Bush, audio segments, such as cheering, and text segments, such as the word “president” and “Bush”. After a statistical processing, which is described below in further detail, the processor 27 performs categorization using category vote histograms. By way of example, if a word in the text file matches a knowledge base keyword, then the corresponding category gets a vote. The probability, for each category, is given by the ratio between the total number of votes per keyword and the total number of votes for a text segment.

In a preferred embodiment, the various components of the segmented audio, video, and text segments are integrated to extract a story or spot a face from the video signal. Integration of the segmented audio, video, and text signals is preferred for complex extraction. For example, if the user desires to retrieve a speech given by a former president, not only is face recognition required (to identify the actor) but also speaker identification (to ensure the actor on the screen is speaking), speech to text conversion (to ensure the actor speaks the appropriate words) and motion estimation-segmentation-detection (to recognize the specified movements of the actor). Thus, an integrated approach to indexing is preferred and yields better results.

With respect to the Internet, which may be accessed as a primary source of content or as a supplemental, secondary source, the content analyzer 25 scans web sites looking for matching stories. Matching stories, if found, are stored in a memory 29 of the content analyzer 25. The content analyzer 25 may also extract terms from the request and pose a search query to major search engines to find additional matching stories. To increase accuracy, the retrieved stories may be matched to find the “intersection” stories. Intersection stories are those stories that were retrieved as a result of both the web site scan and the search query. A description of a method of finding targeted information from web sites in order to find intersection stories is provided in “UniversityIE: Information Extraction From University Web Pages” by Angel Janevski, University of Kentucky, Jun. 28, 2000, UKY-COCS-2000-D-003, the entire disclosure of which is incorporated herein by reference.

In the case of television received from information sources 50, the content analyzer 25 targets channels most likely to have relevant content, such as known news or sports channels. The incoming video signal for the targeted channels is then buffered in a memory of the content analyzer 25, so that the content analyzer 25 perform video content analysis and transcript processing to extract relevant stories from the video signal, as described in detail above.

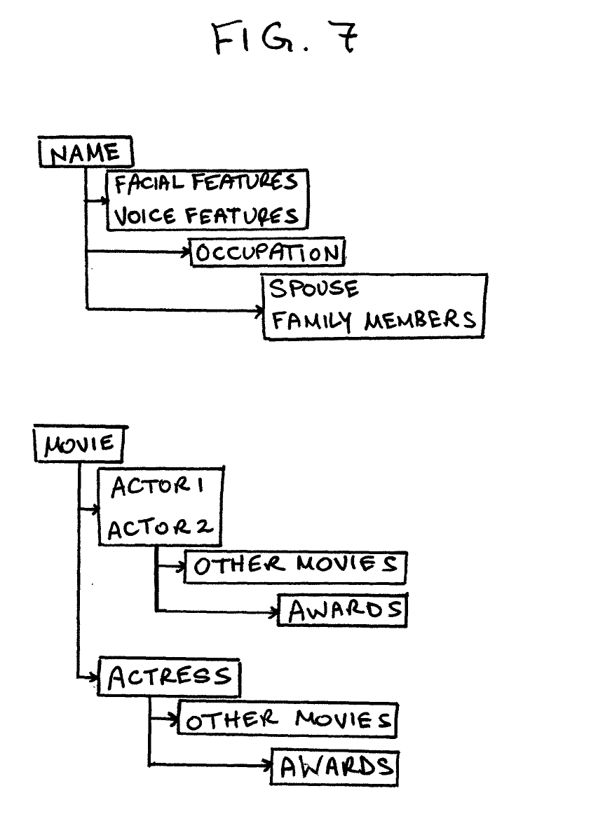

With reference again to FIG. 3, in step 306 the content analyzer 25 then performs “Inferencing and Name Resolution” on the extracted stories. For example, the content analyzer 25 programming may use various ontologies to take advantage of known relationships as described in “Toward Principles for the Design of Onotogies Used for Knowledge Sharing” by Thomas R. Gruber, Aug. 23, 1993, the entire disclosure of which is incorporated herein by reference. In other words, G. W. Bush is “The President of the United States of America” and the “Husband of Laura Bush”. Thus, if in one context the name G. W. Bush appears in the user profile then this fact is also expanded so that all of the above references are also found and the names/roles are resolved when they point to the same person. As a further example a knowledge tree or hierarchy, as shown in FIG. 7, can be stored in the knowledge base.

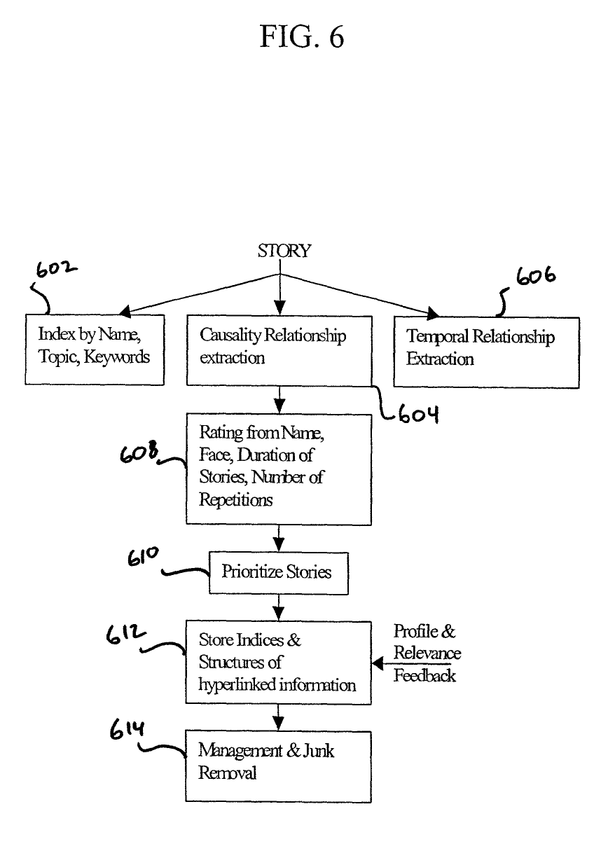

Once a sufficient number of relevant stories are extracted, in the case of television, and found, in the case of the Internet, the stories are preferably ordered based on various relationships, in step 308. With reference to FIG. 6, the stories are preferably indexed by name, topic, and keyword (602), as well as based on a causality relationship extraction (604). An example of a causality relationship is that a person first has to be charged with a murder and then there might be news items about the trial. Also, a temporal relationship (606), e.g., the more recent stories are ordered ahead of older stories, is then used to order the stories, is used to organize and rate the stories. Next, a story rating (608) is preferably derived and calculated from various characteristics of the extracted stories, such as the names and faces appearing in the story, the story's duration, and the number of repetitions of the story on the main news channels (i.e., how many times a story is being aired could correspond to its importance/urgency). Using these relationships, the stories are prioritized (610). Next, the indices and structures of hyperlinked information are stored according to information from the user profile and through relevance feedback of the user (612). Lastly, the information retrieval system performs management and junk removal (614). For example, the system would delete multiple copies of the same story, old stories, which are older than seven (7) days or any other pre-defined time interval. Stories with low ratings or ratings below a predefined threshold may also be removed.

The content analyzer 25 may also support a presentation and interaction function (step 310), which allows the user to give the content analyzer 25 feedback on the relevancy and accuracy of the extraction. This feedback is utilized by profile management functioning (step 312) of the content analyzer 25 to update the user's profile and ensure proper inferences are made depending on the user's evolving tastes.

The user can store a preference as to how often the information retrieval system would access information sources 50 to update the stories indexed in storage device 30, 130. By way of example, the system can be set to access and extract relevant stories either hourly, daily, weekly, or even monthly.

According to another exemplary embodiment, the information retrieval system 10 can be utilized as a subscriber service. This could be achieved in one of two preferred manners. When the embodiment shown in FIG. 1, user could subscribe either through their television network provider, i.e., their cable or satellite provider, or a third party provider, which provider would house and operate the central storage system 30 and the content analyzer 25. At the user's remote site 100, the user would input request information using the input device 120 to communicate with a set top box 110 connected to their display device 115. This information would then be communicated to the centralized retrieval system 20 and processed by the content analyzer 25. The content analyzer 25 would then access the central storage database 30, as described above, to retrieve and extract stories relevant to the user's request.

Once stories are extracted and properly indexed, information related to how a user would access the extracted stories is communicated to the set top box 110 located at the user's remote site. Using the input device 120, the user can then select which of the stories he or she wishes to retrieve from the centralized content analysis system 20. This information may be communicated in the form of a HTML web page having hyperlinks or a menu system as is commonly found on many cable and satellite TV systems today. Once a particular story is selected, the story would then be communicated to the set top box 110 of the user and displayed on the display device 115. The user could also choose to forward the selected story to any number of friends, relatives or others having similar interests to receive such stories.

Alternatively, the information retrieval system 10 of the present invention could be embodied in a product such as a digital recorder. The digital recorder could include the content analyzer 25 processing as well as a sufficient storage capacity to store the requisite content. Of course, one skilled in the art will recognize that a storage device 30, 130 could be located externally of the digital recorder and content analyzer 25. In addition, there is no need to house a digital recording system and content analyzer 25 in a single package either and the content analyzer 25 could also be packaged separately. In this example, a user would input request terms into the content analyzer 25 using the input device 120. The content analyzer 25 would be directly connected to one or more information sources 50. As the video signals, in the case of television, are buffered in memory of the content analyzer, content analysis can be performed on the video signal to extract relevant stories, as described above.

In the service environment, the various user profiles may be aggregated with request term data and used to target information to the user. This information may be in the form of advertisements, promotions, or targeted stories that the service provider believes would be interesting to the user based upon his/her profile and previous requests. In another marketing scheme, the aggregated information can be sold to their parties in the business of targeting advertisements or promotions to users.

As an additional feature for use in either of the embodiments of FIGS. 1 and 2, a user is provided with the functionality to use the information tracking system 10 to make purchases of products related to the retrieved information. The availability of the products may be pushed to the user in targeted manner, as described above, or requested by the user through the system 10 and retrieved by the content analyzer by, for example only, extracting relevant matches from the Internet. For instance, a user could request to purchase products related to a commemorative event (e.g., a bicentennial) and the content analyzer, as discussed in greater detail above, would formulate a search request to attempt to locate matching stories have such items for sale.

While the invention has been described in connection with preferred embodiments, it will be understood that modifications thereof within the principles outlined above will be evident to those skilled in the art and thus, the invention is not limited to the preferred embodiments but is intended to encompass such modifications.

We claim:

1. An information tracker, comprising:
a content analyzer comprising a memory for storing content data received from an information source and a processor for executing a set of machine-readable instructions for analyzing the content data according to query criteria;
an input device communicatively connected to the content analyzer for permitting a user to interact with the content analyzer; and
a display device communicatively connected to the content analyzer for displaying a result of analysis of the content data performed by the content analyzer;
wherein, according to the set of machine-readable instructions, the processor of the content analyzer analyzes the content data to extract and index one or more stories related to the query criteria.

2. The information tracker of claim 1, wherein the processor of the content analyzer uses the query criteria to spot a subject in the content data, extract one or more stories from the content data, resolve and inference names in the extracted one or more stories, and display a link to the extracted one or more stories on the display device.

3. The information tracker of claim 2, wherein, in addition to displaying the link to the extracted one or more stories, the content information about the subject to display one or more links to a shopping web-site, such that the user can purchase goods related to the subject.

4. The information tracker of claim 2, wherein the names in the extracted stories are resolved and inferenced using an ontology.

5. The information tracker of claim 2, wherein, if more than one story is extracted, the processor indexes the stories according to name, topic, and keyword.

6. The information tracker of claim 5, wherein the stories are further ordered based on a causality relationship.

7. The information tracker of claim 5, wherein the stories are further ordered based on a temporal relationship.

8. The information tracker of claim 1, wherein the query criteria includes a request input by the user through the input device and the processor analyzes the content data according to the request.

9. The information tracker of claim 8, wherein the content analyzer further comprises a user profile, which includes information about the user's interests, and the query criteria includes the user profile.

10. The information tracker of claim 9, wherein the user profile is updated by integrating information in the request with existing information in the user profile.

11. The information tracker of claim 8, wherein the content analyzer further comprises a knowledge base, which includes a plurality of known relationships, and the processor analyzes the content data according to the knowledge base.

12. The information tracker of claim 11, wherein one type of the known relationships is a map of a known face to a name.

13. The information tracker of claim 11, wherein one type of the known relationships is a map of a known voice to a name.

14. The information tracker of claim 11, wherein one type of the known relationships is a map of a name to various related information.

15. The information tracker of claim 5, wherein the content analyzer further comprises:
a user profile, which includes information about the user's interests;
a knowledge base which includes a plurality of known relationships including a map of known faces and voices to names and other related information; and
wherein the query criteria includes the user profile and the knowledge base.

16. The information tracker of claim 15, wherein a person spotting function of the machine-readable instructions extracts faces, speech, and text from the content data, makes a first match of known faces to the extracted faces, makes a second match of known voices to the extracted voices, scans the extracted text to make a third match to known names, and calculates a probability of a particular person being present in the content data based on the first, second, and third matches.

17. The information tracker of claim 1, wherein the content data is a video signal.

18. The information tracker of claim 17, wherein the information source is a cable television provider.

19. The information tracker of claim 17, wherein the information source is a satellite television provider.

20. The information tracker of claim 1, wherein the content data is an audio signal.

21. The information tracker of claim 20, wherein the information source is a radio station.

22. The information tracker of claim 1, wherein the content analyzer is communicatively connected to a second information source for providing access to additional content data, the additional content data being analyzed for relevant stories.

23. The information tracker of claim 22, wherein the additional content data is analyzed according to a first approach wherein terms are extracted from the query criteria and used to pose a search request of the second information source and a second approach wherein one or more sites provided by the second information are scanned for matching stories.

24. The information tracker of claim 23, wherein the intersection stories are those matching stories which were retrieved as a result of both the first and second approaches.

25. The information tracker of claim 22, wherein the relevant stories found in the additional content data are compared to find any intersection stories.

26. A method of retrieving information related to a targeted subject, the method comprising:
receiving a video source from an information source into a memory of a content analyzer;
analyzing the video to recognize persons and extract stories from the video source using a query criteria, the query criteria comprising a user profile and knowledge base stored in the content analyzer;
indexing the extracted stories according to a temporal and causal relationships; and
displaying of results of the analysis of the video source.

27. The method of claim 26, wherein the analyzing of the video source to recognize persons comprises extracting faces, speech, and text from the video source, making a first match of known faces to the extracted faces, making a second match of known voices to the extracted voices, scanning the extracted text to make a third match to known names, and calculating a probability of a particular person being present in the content data based on the first, second, and third matches.

28. The method of claim 26 wherein the analyzing of the video source to extract stories comprises segmenting the video source into visual, audio and textual components, fusing the information, segmenting and annotating the story internally, and inferencing the information.

29. The method of claim 26, wherein the indexing of the extracted stories comprises indexing the extracted stories alphabetically.

30. The method of claim 26, wherein the indexing of the extracted stories comprises indexing the extracted stories by topic.

31. The method of claim 26, wherein the indexing of the extracted stories comprises indexing the extracted stories according to keywords matching the query criteria.

32. The method of claim 26, wherein the indexing of the extracted stories comprises extracting a causality relationship.

33. The method of claim 26, wherein the indexing of the extracted stories comprises extracting a temporal relationship.

34. The method of claim 26, wherein the indexing of the extracted stories comprises indexing the extracted stories according to a pre-determined criteria, extracting a causality relationship, and extracting a temporal relationship, calculating a rating for each of the extracted stories from one or more characteristics of the extracted stories, and prioritizing the extracted stories.

35. The method of claim 34, further comprising creating a hyperlinked index to the extracted stories and storing the hyperlinked index.

36. A method of retrieving information related to a targeted subject, the method comprising:
receiving information from a user into a content analyzer, the information related to the user's interests;
receiving first content data into the content analyzer;
analyzing the first content data to extract a story relevant to the information received from the user; and
displaying a link to the story so as to make the story accessible to the user.

37. The method of claim 36, further comprising accessing second content data and searching the second content data for relevant information.

38. The method of claim 36, wherein the content analyzer is centrally located and the user accesses the content analyzer via a communications network.

39. A information tracking retrieval system, comprising:
a centrally located content analyzer in communication with a storage device, the content analyzer being accessible to a plurality of users and information sources via a communications network, and the content analyzer being programmed with a set of machine-readable instructions to:
receive first content data into the content analyzer;
receive a request from at least one of the users;
in response to receipt of the request, analyze the first content data to extract one or more stories relevant to the request; and
provide access to the one or more stories.
